(19) United States
(12) Patent Application Publication
(10) Pub. No.: US 2026/0270587 A1
(43) Pub. Date: Sep. 10, 2026

(54) PHOTOELECTRIC CONVERSION DEVICE

(71) Applicant: CANON KABUSHIKI KAISHA, Tokyo (JP)

(72) Inventors: MASAYUKI TSUCHIYA, Kanagawa (JP); JUMPEI ASHIDA, Cupertino, CA (US)

(21) Appl. No.: 19/656,091

(22) Filed: Apr. 23, 2026

Related U.S. Application Data
(63) Continuation of application No. PCT/JP2024/036426, filed on Oct. 11, 2024.

(30) Foreign Application Priority Data
Oct. 24, 2023 (JP) 2023-182406

(51) Int. Cl. H04N 25/707; G01C 3/08; H04N 25/47

(52) U.S. Cl. CPC H04N 25/707; G01C 3/08; H04N 25/47

(57) ABSTRACT

One aspect of a photoelectric conversion device according to the present disclosure comprises: a pixel array including a plurality of pixel units arranged in a matrix form, each pixel unit having an avalanche photodiode and a counter that generates a count value based on photons entering the avalanche photodiode; a plurality of tile areas defined by dividing the pixel array into a matrix form; and a memory unit arranged in each of the plurality of tile areas, and storing a reference value that is used for detecting an event based on the count value.

### CROSS-REFERENCE TO RELATED APPLICATIONS

This application is a Continuation of International Patent Application No. PCT/JP2024/036426, filed October 11, 2024, which claims the benefit of Japanese Patent Application No. 2023-182406, filed October 24, 2023, both of which are hereby incorporated by reference herein in their entirety.

### BACKGROUND

### Field of the Technology

The present disclosure relates to a photoelectric conversion device.

### Description of the Related Art

Japanese Patent Laid-Open No. 2020-096347 discloses a semiconductor device comprising pixel blocks arranged in a matrix form, each pixel block including a detection pixel and a counting pixel. The detection pixel detects occurrence of events based on change in the amount of incident light. The counting pixel includes a single-photon avalanche diode (SPAD) and counts the number of photons entering the SPAD.

According to Japanese Patent Laid-Open No. 2020-096347, the change in the amount of light in the detection pixel is detected based on photocurrent generated by a photodiode. On the other hand, the counting pixel counts the number of photons entering the SPAD. That is, the detection pixel and the counting pixel generate and process signals different from each other. Thus, in viewpoints of noise tolerance of signals, the circuit scale of each pixel, and the like, a difference may occur between the detection pixel and the counting pixel included in the same pixel block.

### SUMMARY

The present disclosure has been made in view of the above-described problem, and is directed to providing a photoelectric conversion device capable of solving the problem that may occur due to the difference in configuration between the detection pixel and the counting pixel.

A photoelectric conversion device according to one aspect of the present disclosure comprises: a pixel array including a plurality of pixel units arranged in a matrix form, each pixel unit having an avalanche photodiode and a counter that generates a count value based on photons entering the avalanche photodiode; a plurality of tile areas defined by dividing the pixel array into a matrix form; and a memory unit arranged in each of the plurality of tile areas, and storing a reference value that is used for detecting an event based on the count value.

Features of the present disclosure will become apparent from the following description of embodiments with reference to the attached drawings.

### BRIEF DESCRIPTION OF THE DRAWINGS

FIG. 1 is a schematic diagram of a photoelectric conversion device according to a first embodiment.

FIG. 2 is a diagram showing an arrangement example of a sensor substrate according to the first embodiment.

FIG. 3 is a block diagram showing a schematic configuration of the photoelectric conversion device according to the first embodiment.

FIG. 4 is a block diagram showing a schematic configuration of a tile area according to the first embodiment.

FIG. 5 is a diagram showing a schematic configuration of a pixel unit according to the first embodiment.

FIG. 6 is a timing chart showing the operation of the pixel unit in the first embodiment.

FIG. 7 is a diagram showing an example of a layout in a tile area according to the first embodiment.

FIG. 8A is a diagram showing an example of an arrangement of event detection pixels and imaging pixels in a tile area according to the first embodiment.

FIG. 8B is a diagram showing an example of the arrangement of event detection pixels and imaging pixels in the tile area according to the first embodiment.

FIG. 9 is a diagram showing an example of an arrangement of color filters arranged in a tile area according to the first embodiment.

FIG. 10 is a block diagram showing a schematic configuration of a photoelectric conversion device according to a second embodiment.

FIG. 11 is a block diagram showing a schematic configuration of a tile area according to the second embodiment.

FIG. 12 is a diagram showing a modification of the layout of pixels in the tile area according to the second embodiment.

FIG. 13 is a diagram showing a modification of the pattern connecting the tile areas according to the second embodiment.

FIG. 14 is a diagram showing a schematic configuration of a pixel unit according to a third embodiment.

FIG. 15 is a timing chart showing the operation of the pixel unit in the third embodiment.

FIG. 16 is a block diagram of an imaging system according to a fourth embodiment.

FIG. 17 is a block diagram of a light detection system according to a fifth embodiment.

FIG. 18 is a schematic diagram of an endoscopic surgery system according to a sixth embodiment.

FIG. 19A is a schematic diagram of a light detection system according to a seventh embodiment.

FIG. 19B is a schematic diagram of mobile object in the seventh embodiment.

FIG. 19C is a schematic diagram of mobile object in the seventh embodiment.

FIG. 19D is a schematic diagram of mobile object in the seventh embodiment.

FIG. 20 is a flowchart showing an operation of the light detection system according to the seventh embodiment.

FIG. 21A is a diagram showing a specific example of an electronic apparatus according to an eighth embodiment.

FIG. 21B is a diagram showing a specific example of the electronic apparatus according to the eighth embodiment.

### DESCRIPTION OF THE EMBODIMENTS

Hereinafter, preferred embodiments of the present disclosure will be described in detail with reference to the accompanying drawings. The following embodiments are intended to embody the technical idea of the present invention, and do not limit the present invention. The sizes and positional relationships of members shown in the drawings may be exaggerated for clarity of description. In the following description, elements having functions common to the drawings are denoted by the same reference numerals, and redundant description may be omitted or simplified.

### First Embodiment

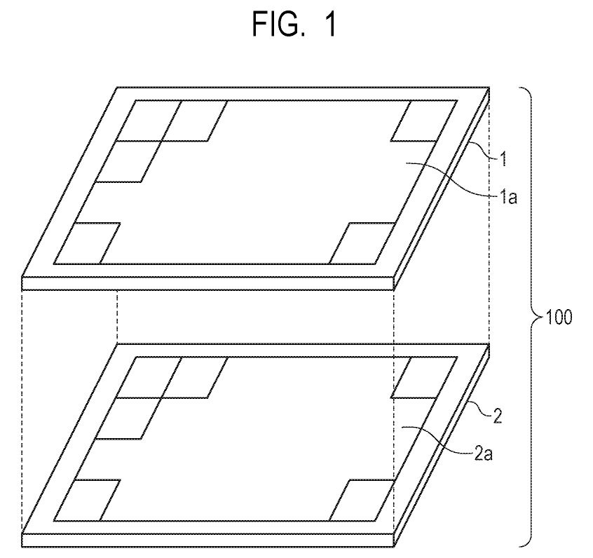

The configuration of the photoelectric conversion device according to the present embodiment will be described with reference to FIGS. 1 to 9. The photoelectric conversion device includes a SPAD pixel including an avalanche photodiode (hereinafter referred to as "APD"). The conductivity type of charge used as signal charge among charge pairs generated in the APD is referred to as a first conductivity type. The first conductivity type refers to a conductivity type in which a charge having the same polarity as a signal charge is a majority carrier. The conductivity type opposite to the first conductivity type is referred to as a second conductivity type. Hereinafter, an example in which the signal charge is an electron, the first conductivity type is an N-type, and the second conductivity type is a P-type will be described, but the signal charge may be a hole, the first conductivity type may be a P-type, and the second conductivity type may be an N-type.

FIG. 1 is a schematic diagram of a photoelectric conversion device according to the present embodiment, and shows a configuration of a stacked photoelectric conversion device 100. The photoelectric conversion device 100 includes a sensor substrate 1 (first substrate) and a circuit substrate 2 (second substrate) stacked on each other, and the sensor substrate 1 and the circuit substrate 2 are electrically connected to each other. The photoelectric conversion device according to the present embodiment is a back-illuminated photoelectric conversion device in which light is incident from the first surface of the sensor substrate 1 and the circuit substrate 2 is disposed on the second surface of the sensor substrate 1. The sensor substrate 1 includes a first semiconductor layer having a photoelectric conversion element described later and a first wiring structure. The circuit substrate 2 includes a second semiconductor layer having a circuit such as a signal processor described later and a second wiring structure. The photoelectric conversion device 100 is configured by stacking the second semiconductor layer, the second wiring structure, the first wiring structure, and the first semiconductor layer in this order.

Hereinafter, the sensor substrate 1 and the circuit substrate 2 may be diced chips, but are not limited to the chips. For example, each substrate may be a wafer. In addition, each substrate may be diced after being stacked in a wafer state, or chips may be stacked and bonded after being formed into chips. A pixel array 1a is disposed on the sensor substrate 1, and a circuit area 2a for processing signals detected by the pixel array 1a is disposed on the circuit substrate 2.

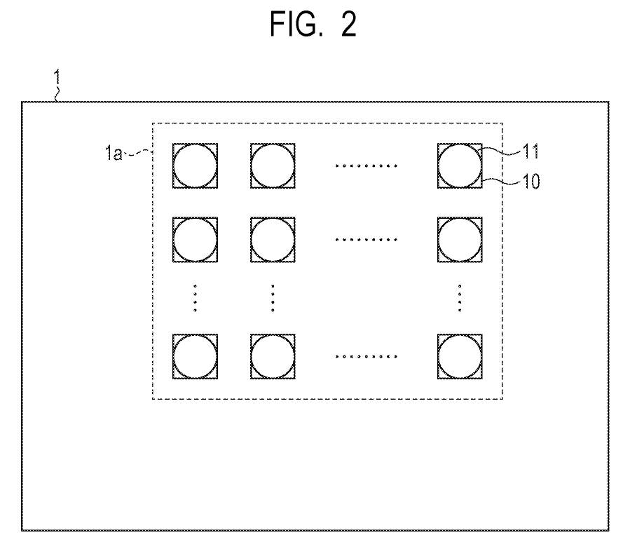

FIG. 2 is a diagram showing an arrangement example of the sensor substrate 1. Each of multiple pixels 10 includes an APD 11, the pixels 10 are arranged in a two-dimensional array in a plan view, and form the pixel array 1a.

The pixel 10 is typically a pixel for forming an image, but it is not necessarily required to form an image in a case where the pixel 10 is used for TOF (Time of Flight). That is, the pixel 10 may be a pixel for measuring the time at which light arrives and the amount of light.

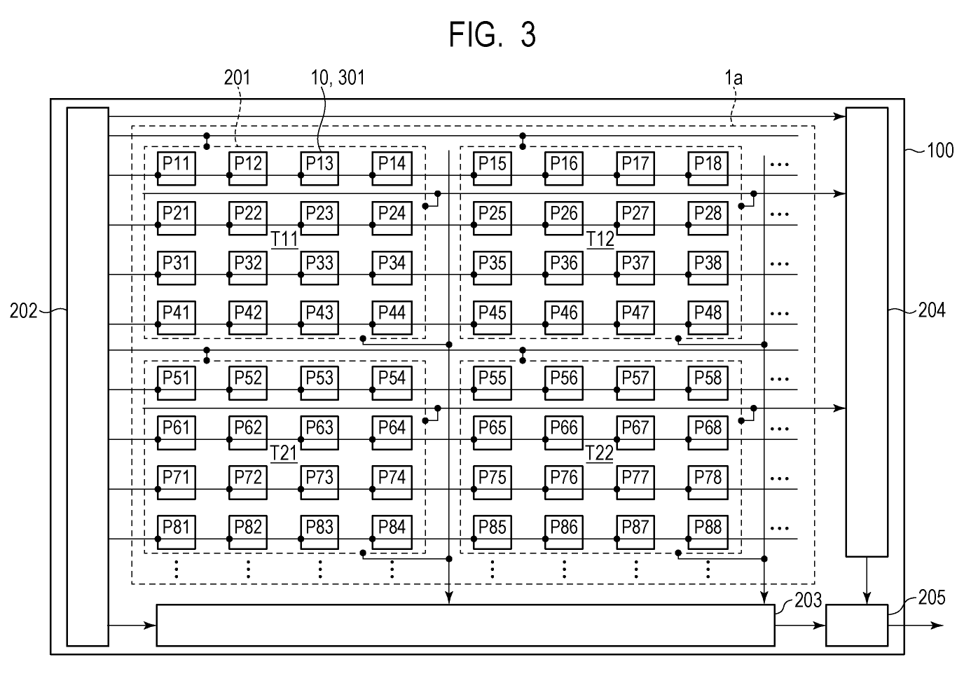

FIG. 3 is a block diagram showing a schematic configuration of the photoelectric conversion device according to the present embodiment. The photoelectric conversion device 100 according to the present embodiment includes the pixel array 1a, a controller 202, a first processor 203, a second processor 204, and an input/output (I/O) unit 205.

The pixel array 1a includes multiple tile areas 201 having a matrix form arranged in the directions of rows and columns. FIG. 3 shows the tile areas 201 arranged in first and second rows and first and second columns together with reference symbols indicating row numbers and column numbers. For example, the tile area 201 arranged in the second row and the first column is denoted by a reference symbol "T21".

Each of the multiple tile areas 201 includes multiple pixel units 301. The multiple pixel units 301 include the multiple pixels 10 arranged in a matrix of M rows and N columns. M and N are integers of 1 or more, and at least one of M and N is an integer of 2 or more. FIG. 3 shows the pixels 10 arranged in first to eighth pixel rows and first to eighth pixel columns together with reference symbols indicating a row number and a column number. For example, the pixel 10 arranged in the second pixel row and the first pixel column is denoted by a reference symbol "P21".

Pixel signals output from the pixel unit 301 are processed in the tile area 201. The processing of the pixel signals will be described later. The tile area 201 is connected to the first processor 203 through a vertical output line, and is connected to the second processor 204 through a horizontal output line. The signals output from the tile area 201 are transmitted to the first processor 203 or the second processor 204.

The controller 202 controls operations of the tile areas 201, the pixel units 301, the first processor 203, and the second processor 204. The controller 202 is electrically connected to each of the tile areas 201, each of the pixel units 301, the first processor 203, and the second processor 204. The controller 202 transmits control signals for controlling the tile areas 201, the pixel units 301, the first processor 203, and the second processor 204. The tile areas 201, the pixel units 301, the first processor 203, and the second processor 204 perform signal processing, signal transmission, and the like based on the received control signal. In the present embodiment, based on the received control signal, the tile area 201 transmits signals output from a part of the multiple pixel units 301 to the second processor 204, and transmits signals output from pixel units other than the part of the pixel units to the first processor 203. In the following descriptions, the part of the pixel units is referred to as an event detection pixel unit or simply as a detection pixel unit. The pixel units other than the detection pixel unit are referred to as imaging pixel units or frame pixel units.

The first processor 203 and the second processor 204 perform predetermined arithmetic processing on the signals received from the tile area 201, and output results of the arithmetic processing to the I/O unit 205. The I/O unit 205 outputs the signals received from the first processor 203 and the second processor 204 to an external device such as an image processing circuit.

In the present embodiment, the first processor 203 processes the pixel signals transmitted from the imaging pixel units, and the second processor 204 processes the pixel signals transmitted from the event detection pixel unit. However, the photoelectric conversion device 100 according to the present disclosure may be configured to include a single processor. For example, the first processor 203 may be configured to process the pixel signals transmitted from the imaging pixel units and the pixel signals transmitted from the event detection pixel unit.

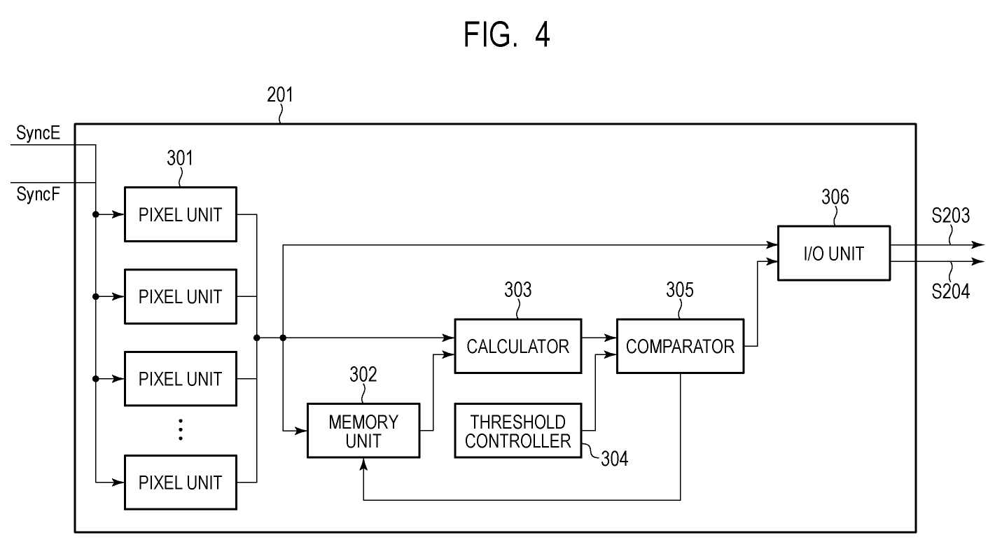

FIG. 4 is a block diagram showing a schematic configuration of the tile area 201 according to the present embodiment. The tile area 201 includes pixel units 301, a memory unit 302, a calculator 303, a threshold controller 304, a comparator 305, and an input/output (I/O) unit 306.

The pixel unit 301 detects photons entering the pixel 10, counts the incident photons, and processes and outputs the counted number of photons as a count value. The pixel unit 301 is connected to the memory unit 302, the calculator 303, and the I/O unit 306. The pixel unit 301 includes the event detection pixel unit used to detect an event and an imaging pixel unit used to output imaging data. The pixel unit 301 receives an event synchronization signal SyncE and a frame synchronization signal SyncF transmitted from the controller 202. The event synchronization signal SyncE and the frame synchronization signal SyncF control the operation of the pixel unit 301. For example, the event synchronization signal SyncE can operate the event detection pixel unit among the pixel units 301 at a frame rate of 1000 fps. The frame synchronization signal SyncF can operate the imaging pixel unit among the pixel units 301 at a frame rate of 60 fps. In the present embodiment, the pixel unit 301 that operates based on the event synchronization signal SyncE is the event detection pixel unit, and the pixel unit 301 that operates based on the frame synchronization signal SyncF is the imaging pixel unit. The numbers of event detection pixel units and imaging pixel units can be arbitrarily selected. For example, the tile area 201 may include a selecting switch (not shown) connected to the controller 202 and each of the pixel units 301. The controller 202 can operate each of the pixel units 301 as the event detection pixel unit or the imaging pixel unit through the selecting switch.

The memory unit 302 stores a reference value used to detect an event. The reference value may be a count value output from the event detection pixel unit (pixel unit 301) when an event occurred in the past. The reference value may be updated when an event occurs. The memory unit 302 is connected to the calculator 303 and the comparator 305. The memory unit 302 transmits the reference value to the calculator 303. In addition, the memory unit 302 receives the signal transmitted from the comparator 305. The signal transmitted from the comparator 305 to the memory unit 302 will be described later.

The memory unit 302 may be arbitrarily configured according to the number of event detection pixel units. For example, the tile area 201 may include the memory units 302 as many as the event detection pixel units, and each memory unit 302 may hold the reference values of the corresponding event detection pixel units. As another example, a single memory unit 302 may be configured to have a capacity allowing to store all reference values corresponding to multiple event detection pixel units.

The calculator 303 performs arithmetic operation on the signals received from the pixel units 301 and the memory unit 302. The calculator 303 is connected to the pixel units 301, the memory unit 302, and the comparator 305. The calculator 303 receives the count value from the event detection pixel unit among the pixel units 301. The count value indicates the number of photons having entered the pixel 10 of the event detection pixel unit in a predetermined period. Further, the calculator 303 receives the reference value from the memory unit 302. The calculator 303 performs a predetermined arithmetic operation based on the count value and the reference value. Specifically, the calculator 303 subtracts the reference value from the count value. If the result of subtraction (difference) is a positive value, it indicates that a larger number of photons than the reference value has entered the event detection pixel unit in a predetermined period. On the other hand, if the difference is a negative value, it indicates that a smaller number of photons than the reference value has entered the event detection pixel unit in a predetermined period. The calculator 303 transmits a result of the calculation to the comparator 305.

The threshold controller 304 is connected to the comparator 305, and transmits a predetermined threshold value to the comparator 305. The threshold value is used by the comparator 305 to determine whether or not an event has occurred in the event detection pixel unit. The threshold controller 304 may supply two or more threshold values to the comparator 305. For example, the threshold controller 304 may transmit a first threshold Th1 and a second threshold Th2 to the comparator 305. The first threshold Th1 is used in the comparator 305 when the result of subtraction in the calculator 303 shows a positive value. The second threshold Th2 is used in the comparator 305 when the result of subtraction in the calculator 303 shows a negative value. The first threshold Th1 and the second threshold Th2 are different from each other. The first threshold Th1 and the second threshold Th2 may be fixed values or may be appropriately changed. For example, the first threshold Th1 and the second threshold Th2 may be changed according to a change in the reference value stored in the memory unit 302. For example, in a case where the reference value stored in the memory unit 302 is A, the threshold controller 304 can change the first threshold value to Th1×α(A) and change the second threshold value to Th2 ×β(A). Here, both the parameters α and β are values that vary in accordance with a change in the reference value A. The parameters α and β may be different values from each other. The amounts of change of the parameters α and β due to the change of the reference value A may be different from each other. Therefore, the amount of change in the first threshold value due to a change in the reference value A may be different from the amount of change in the second threshold value due to the change in the reference value A. Further, an arbitrary offset value may be added to the first threshold value and the second threshold value. For example, the threshold controller 304 can change the first threshold value to Th1 ×α(A)+X (where X is an arbitrary value). Similarly, the threshold controller 304 can change the second threshold value to Th2 ×β(A)+Y (where Y is an arbitrary value). When the thresholds are changed, the threshold controller 304 may be configured to appropriately acquire the reference value A stored in the memory unit 302. The threshold controller 304 appropriately changes the threshold values. Therefore, the photoelectric conversion device 100 of the present disclosure allows to accurately detect an event according to environments, conditions, or the like of scenes to be captured.

The comparator 305 compares the signal received from the calculator 303 with the signal received from the threshold controller 304. The comparator 305 is connected to the memory unit 302, the calculator 303, the threshold controller 304, and the I/O unit 306. The comparator 305 receives the result of calculation from the calculator 303 and receives a threshold value from the threshold controller 304. The comparator 305 compares the result of calculation with the threshold value, and determines whether or not a first event has occurred in the event detection pixel unit. For example, if a result of calculation by the calculator 303 is equal to or greater than the first threshold value, the comparator 305 determines that the first event has occurred. The occurrence of the first event indicates that the amount of increase in the number of photons entering the event detection pixel unit in a predetermined period has reached a predetermined condition. If the result of calculation by the calculator 303 is equal to or less than the second threshold, the comparator 305 determines that a second event has occurred. The occurrence of the second event indicates that the amount of decrease in the number of photons entering the event detection pixel unit in a predetermined period has reached a predetermined condition. If the result of calculation by the calculator 303 is within a range of the set thresholds, the comparator 305 determines that no event has occurred. The comparator 305 transmits a result of determination to the I/O unit 306. For example, the comparator 305 outputs +1 if determined that the result of calculation exceeds the first threshold value, outputs -1 if determined that the result of calculation exceeds the second threshold value, and outputs 0 if determined that the result of calculation is within a range of the set threshold values. When it is determined that an event has occurred, the comparator 305 updates the reference value stored in the memory unit 302. Specifically, the reference value of the detection pixel unit that has detected the event is updated to the count value output from that detection pixel unit. In order to update the count value, the comparator 305 transmits a signal for updating the reference value to the memory unit 302 or the controller 202.

The I/O unit 306 is an interface that receives a signal processed in the tile area 201 and transmits the signal to the outside of the tile area 201. The I/O unit 306 receives a count value (S203) transmitted from the imaging pixel unit among the pixel units 301, and outputs the count value to the first processor 203. The transmitted count value corresponds to the number of photons entering the pixel 10 of the imaging pixel unit within a predetermined period. Further, the I/O unit 306 receives a result of the event detection (S204) from the comparator 305, and outputs a result of the detection to the second processor 204. The I/O unit 306 may be configured to output a result of the event detection to the second processor 204 only when the occurrence of event is detected by the comparator 305.

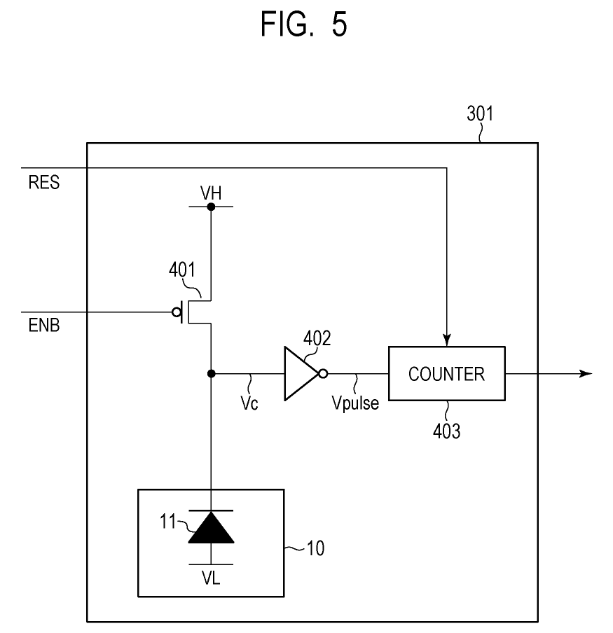

FIG. 5 is a diagram showing a schematic configuration of the pixel unit 301 according to the present embodiment. The pixel unit 301 includes the pixel 10 including the APD 11, a PMOS transistor 401, an inverter 402, and a counter 403. A pulse signal ENB is applied from the controller 202 to the gate of the PMOS transistor 401. A voltage VH is applied to one of the source and the drain of the PMOS transistor 401, and the other of the source and the drain is connected to a cathode of the APD 11 and one end of the inverter 402. A voltage VL is applied to the anode of the APD 11. In the present embodiment, the voltage VH is set to about 3.3 V, and the voltage VL is set to about -20 V. The other end of the inverter 402 is connected to the counter 403. A signal RES is input from the controller 202 to the counter 403. The controller 202 controls the counter 403 via the signal RES.

When the source and the drain of the PMOS transistor 401 are brought into a conductive state (ON state) in response to the signal ENB, a reverse bias voltage due to a potential difference between the voltage VH and the voltage VL is applied to the APD 11. The reverse bias voltage is set to be higher than the breakdown voltage of the APD 11. Thus, the APD 11 operates as an avalanche photodiode in the Geiger mode.

The inverter 402 receives a signal Vc generated according to the operation of the APD 11, and outputs a waveform-shaped pulse signal Vpulse to the counter 403.

The counter 403 receives the pulse signal output from the inverter 402, counts rising edges of the pulse signal, and stores the counted number as a count value. The count value stored in the counter 403 is a digital value indicating the number of photons having entered the pixel 10 in a predetermined period. In order for the counter 403 to count rising edges, the inverter 402 is used as a buffer. In a case of using a buffer that does not invert the polarity, the counter 403 may be configured to count falling edges of the pulse signal output from the buffer. The counter 403 is connected to the memory unit 302, the calculator 303, and the I/O unit 306. The count value stored in the counter 403 is output to the memory unit 302, the calculator 303, and the I/O unit 306.

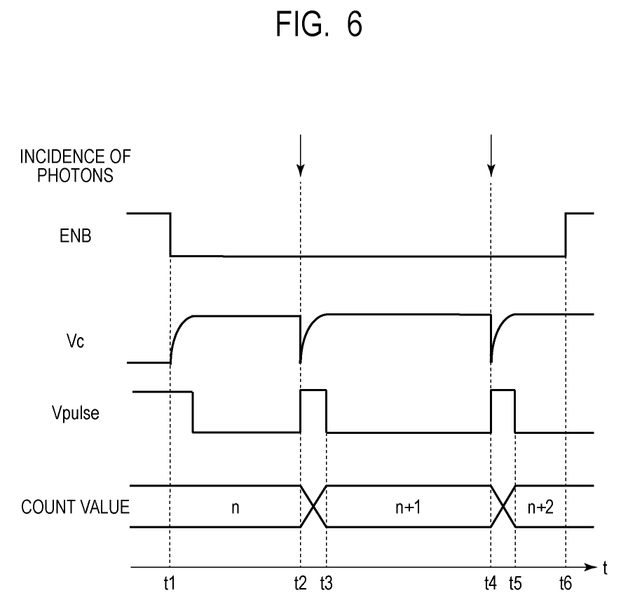

FIG. 6 is a timing chart showing the operation of the pixel unit 301 according to the present embodiment. FIG. 6 shows timing charts of photons entering the pixel 10, the signal ENB input to the gate of the PMOS transistor 401, the signal Vc generated based on the operation of the APD 11, the pulse signal Vpulse waveform-shaped by the inverter 402, and the count value in the counter 403, respectively.

In a period before time t1, the signal ENB is at a high level, the signal Vc is at a low level, the signal Vpulse is at a high level, and the count value is n. The high-level signal ENB is applied to the gate of the PMOS transistor 401, and the source and the drain of the PMOS transistor 401 are in a non-conductive state (OFF state). The signal Vc is at a low level, and the APD 11 is not charged.

At time t1, the signal ENB transitions from a high level to a low level, and the PMOS transistor 401 switches from the OFF state to the ON state. In the period from time t1 to time t2, the signal ENB is maintained at a low level. The APD 11 is charged via the PMOS transistor 401, and the signal Vc transitions from a low level to a high level. That is, the APD 11 is enabled to generate avalanche multiplication in response to incidence of a photon. In response to the transition of the signal Vc to a high level, the signal Vpulse transitions from a high level to a low level.

At time t2, a photon enters the pixel 10, and the APD 11 generates avalanche multiplication. The signal Vc transitions from a high level to a low level due to the generation of avalanche multiplication. The signal Vc exceeds a threshold value of the inverter 402, and the signal Vpulse transitions from a low level to a high level. In response to the transition of the signal Vpulse to a high level, the counter 403 increases the stored count value from n to n+1 by one LSb (Least Significant bit).

In the period from time t2 to time t3, the signal ENB is maintained at a low level. The APD 11 is recharged via the PMOS transistor 401. At time t3, the signal Vc falls below the threshold of the inverter 402, and the signal Vpulse transitions from a high level to a low level. In the period from time t3 to time t4, the signal ENB is maintained at a low level, the signal Vc is maintained at a high level, and the signal Vpulse is maintained at a low level.

At time t4, a photon enters the pixel 10, and the APD 11 generates avalanche multiplication. The signal Vc transitions from a high level to a low level due to the generation of avalanche multiplication. The signal Vc exceeds the threshold value of the inverter 402, and the signal Vpulse transitions from a low level to a high level. In response to the transition of the signal Vpulse to a high level, the counter 403 increases the stored count value from n+1 to n+2 by one LSb.

In the period from time t4 to time t5, the signal ENB is maintained at a low level. The APD 11 is recharged via the PMOS transistor 401. At time t5, the signal Vc falls below the threshold of the inverter 402, and the signal Vpulse transitions from a high level to a low level. During the period from time t5 to time t6, the signal ENB is maintained at a low level, the signal Vc is maintained at a high level, and the signal Vpulse is maintained at a low level.

At time t6, the signal ENB transitions from a low level to a high level, and the PMOS transistor 401 switches from the ON state to the OFF state. The APD 11 is not supplied with the voltage VH via the PMOS transistor 401. That is, the APD 11 is not recharged.

The period in which photons are counted (counting period) can be adjusted by changing the period in which the signal ENB is at a low level. The counting period of the event detection pixel unit may be different from the counting period of the imaging pixel unit. That is, the controller 202 may supply separate signals ENB to the event detection pixel unit and the imaging pixel unit depending on frame rates applied to the pixel unit 301. For example, the event detection pixel unit may be driven at a relatively high frame rate, and the imaging pixel unit may be driven at a relatively low frame rate. This configuration allows to detect the occurrence of events with high accuracy through the event detection pixel unit and simultaneously capture high-definition images through the imaging pixel units.

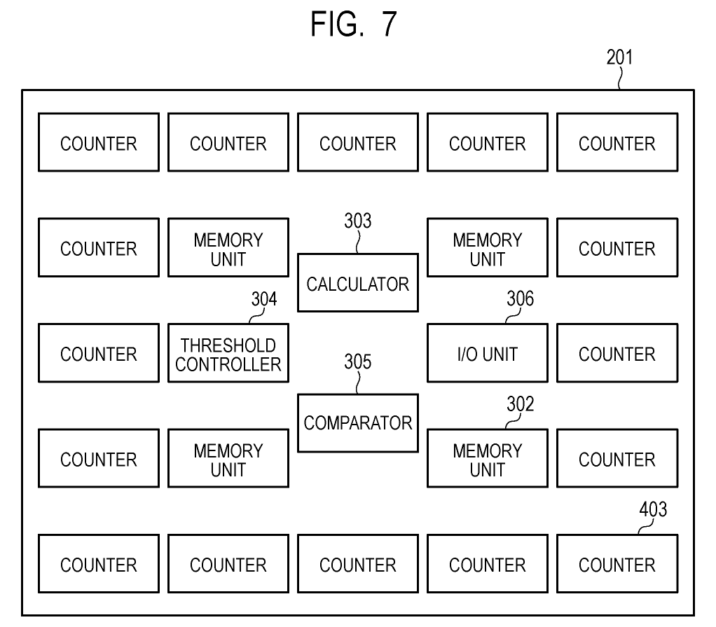

FIG. 7 is a diagram showing an example of a layout in the tile area 201 according to the present embodiment. FIG. 7 shows the counters 403 of the pixel units 301 and the memory units 302 arranged in the tile area 201. In the present example, the counters 403 are arranged on the outer side (peripheral portion) of the tile area 201, and the memory units 302 are arranged on the inner side (central portion) of the tile area 201 so as to be surrounded by the counters 403. Further, the calculator 303, the threshold controller 304, the comparator 305, and the I/O unit 306 are arranged in the central portion of the tile area 201 so as to be surrounded by the counters 403. The multiple counters 403 share the memory units 302, the calculator 303, the threshold controller 304, the comparator 305, and the I/O unit 306. Count values output from each of the counters 403 are transmitted to the shared memory units 302, the calculator 303, and the I/O unit 306, and are processed and calculated by the shared threshold controller 304 and the comparator 305. Adopting the layout as shown in the present example allows to make the transmission distance of data from each of the pixel units 301 arranged in the tile area 201 uniform. In this example, the tile area 201 includes sixteen counters 403 (pixel units 301) that share four memory units 302, one calculator 303, one threshold controller 304, one comparator 305, and one I/O unit 306. However, the configuration of the tile area 201 according to the present disclosure is not limited to the example shown in FIG. 7. For example, the tile area 201 may include a single memory unit 302, and the memory unit 302 may be configured to have a capacity allowing to store the number of reference values corresponding to the number of event detection pixel units (pixel units 301).

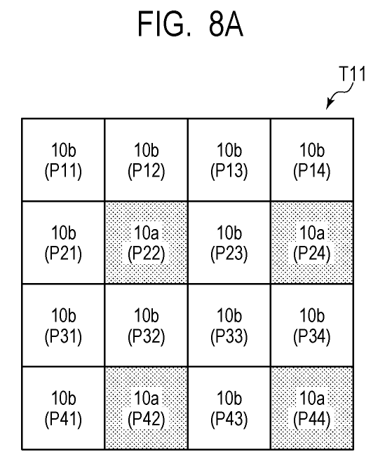

FIGS. 8A and 8B are diagrams showing examples of the arrangement of the event detection pixels and the imaging pixels in the tile area 201 according to the present embodiment. In this example, the pixels 10 are arranged in a 4×4 matrix in the tile area 201. The controller 202 can operate any part of the pixels 10 in the tile area 201 as the event detection pixels 10a via selecting switches (not shown). In addition, the controller 202 can operate the pixels other than the event detection pixels 10a as the imaging pixels 10b via the selecting switches. For example, as shown in FIG. 8A, the controller 202 can operate the pixels P22, P24, P42, and P44 in the tile area T11 as the event detection pixels 10a, and operate the other pixels as the imaging pixels 10b. As another example, as shown in FIG. 8B, the controller 202 can operate the pixels P51, P61, P71, and P81 in the tile area T21 as the event detection pixels 10a and operate the other pixels as the imaging pixels 10b. The controller 202 can arbitrarily and separately select the number and arrangement of the event detection pixels 10a and the imaging pixels 10b for each of the tile areas 201 via the selecting switches. That is, the numbers of the event detection pixels 10a and the imaging pixels 10b according to the present disclosure are variable. The controller 202 can increase or decrease the numbers of the event detection pixels 10a and the imaging pixels 10b. In addition, as shown in FIGS. 8A and 8B, the controller 202 can change the arrangement of the event detection pixels 10a and the imaging pixels 10b.

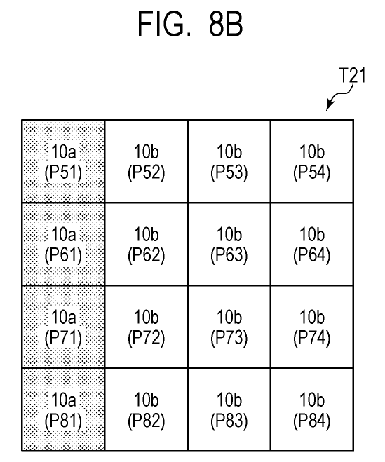

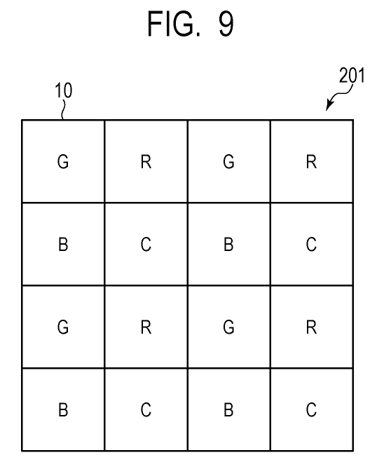

FIG. 9 is a diagram showing an example of the arrangement of color filters disposed in the tile area 201 according to the present embodiment. In this example, the multiple pixels 10 are arranged in a matrix form in the tile area 201. Four green color filters G, four red color filters R, four blue color filters B, and four transparent color filters C (transparent layers) are disposed on the pixels 10. In this example, the transparent color filters C are disposed on the four event detection pixels 10a shown in FIG. 8A, and four color filters G, four color filters R, and four color filters B are disposed on the twelve imaging pixels 10b. In this example, four types of filters are used and four filters per type are arranged in each of the tile areas 201. However, the combination of the number of color filters and the type of color filters included in the photoelectric conversion device 100 according to the present disclosure is not limited to this example, and can be arbitrarily changed.

According to the present disclosure, each of the pixel units 301 in the tile area 201 includes the pixel 10 including the APD 11 and the counter 403 that stores the count value of incident photons. The pixel units 301 share the memory unit 302, the calculator 303, the threshold controller 304, the comparator 305, and the I/O unit 306. A part of the pixel units 301 operates as the detection pixel unit for detecting an event. The detection pixel unit outputs a count value that is a digital value to the calculator 303, and the comparator 305 detects occurrence of an event based on the count value. That is, the photoelectric conversion device according to the present disclosure does not have a problem of noise caused by an analog signal such as a photocurrent generated from a photodiode when an event is detected. The event detection pixel unit included in the photoelectric conversion device according to the present disclosure has the same configuration as the imaging pixel unit. The memory unit, the calculator, the threshold controller, the comparator, and the I/O unit used when detecting an event are shared by the multiple event detection pixels. Therefore, according to the present disclosure, it becomes possible to equalize the circuit scale of the pixel units arranged in a matrix form in the tile area. Further, in the photoelectric conversion device 100 according to the present disclosure, all the pixel units 301 included in the tile area 201 can function as both the event detection pixel unit and the imaging pixel unit. That is, the photoelectric conversion device 100 can set the number and arrangement of the event detection pixel units and the imaging pixel units separately for each of the tile areas 201. In addition, since the event detection pixel units and the imaging pixel units have the same configuration, the photoelectric conversion device 100 according to the present disclosure can simplify the manufacturing process of the pixel units and reduce the manufacturing cost.

### Second Embodiment

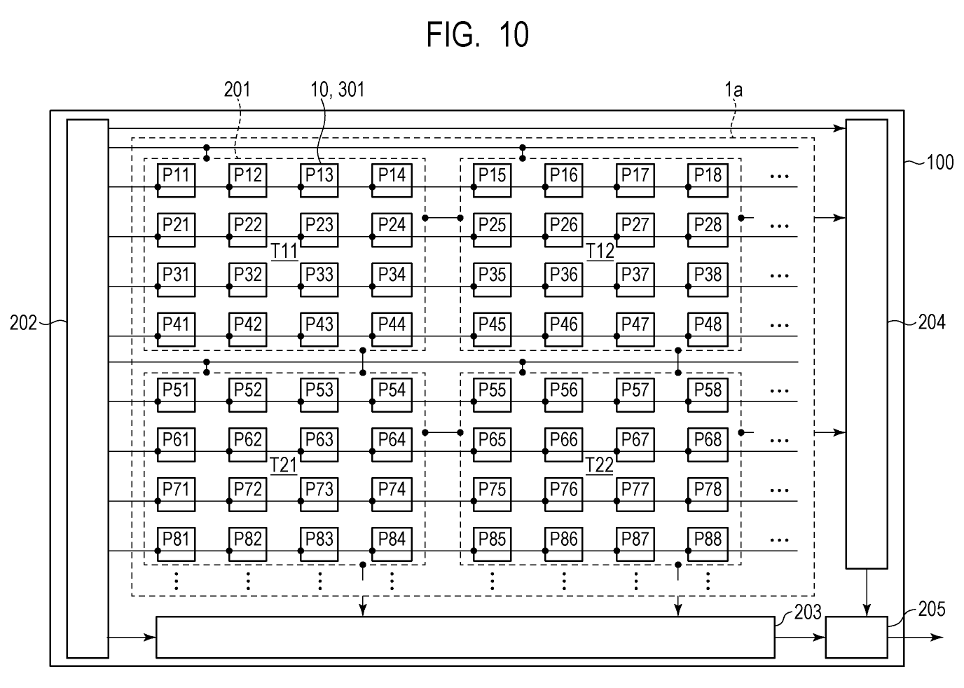

A photoelectric conversion device according to the second embodiment of the present disclosure will be described with reference to FIGS. 10 to 13, focusing on differences from the first embodiment.

FIG. 10 is a block diagram showing a schematic configuration of a photoelectric conversion device according to the present embodiment. The photoelectric conversion device 100 according to the present embodiment differs from the first embodiment in that the device 100 does not include a vertical output line and a horizontal output line. According to the present embodiment, a signal output from the tile area 201 is transferred to another adjacent tile area 201. For example, a signal output from the tile area T11 according to the present embodiment is directly transferred to the tile areas T12 and T21 adjacent in the row direction and the column direction respectively without passing through the vertical output line and the horizontal output line. The signal output from the tile area 201 is transmitted to the first processor 203 or the second processor 204 via one or more separate tile areas 201. The controller 202 controls the direction in which the signal is transferred according to the types of signals output from the tile area 201. For example, the controller 202 determines whether to transfer the signal in the row direction (tile area T12) or the column direction (tile area T21) based on the type of the signal output from the tile area T11. That is, the controller 202 determines to which of the first processor 203 and the second processor 204 the signal is to be transmitted based on the type of the signal output from the tile area 201. For example, the controller 202 can transfer the pixel signal from the imaging pixel unit to the tile area 201 adjacent in the column direction, and cause the first processor 203 to process the signal. In addition, the controller 202 can transfer the pixel signal from the event detection pixel to the tile area 201 adjacent in the row direction, and cause the second processor 204 to process the signal.

FIG. 11 is a block diagram showing a schematic configuration of the tile area 201 according to the present embodiment. The I/O unit 306 included in the tile area 201 of the present embodiment directly receives a signal from an I/O unit 306 of another tile area 201 adjacent in the row direction and the column direction. That is, the I/O unit 306 receives the signal DataH transferred from an I/O unit 306 of the tile area 201 adjacent in the row direction. The I/O unit 306 transfers the signal DataH to an I/O unit 306 of another tile area 201 adjacent in the row direction. Similarly, the I/O unit 306 receives the signal DataV transferred from an I/O unit 306 of the tile area 201 adjacent in the column direction. The I/O unit 306 transfers the signal DataV to an I/O unit 306 of another tile area 201 adjacent in the column direction. For example, the I/O unit 306 of the tile area T22 transfers the signal received from the tile area T21 to the I/O unit 306 of the tile area T23. The I/O unit 306 of the tile area T22 transfers the signal received from the tile area T12 to the I/O unit 306 of the tile area T32. The signals transferred to the I/O unit 306 of the tile area T23 are sequentially transferred to the tile areas 201 adjacent in the row direction, and finally transmitted to the second processor 204. The signals transferred to the I/O unit 306 of the tile area T32 are sequentially transferred to the tile areas 201 adjacent in the column direction, and finally transmitted to the first processor 203. The first processor 203 and the second processor 204 respectively process the transmitted signals.

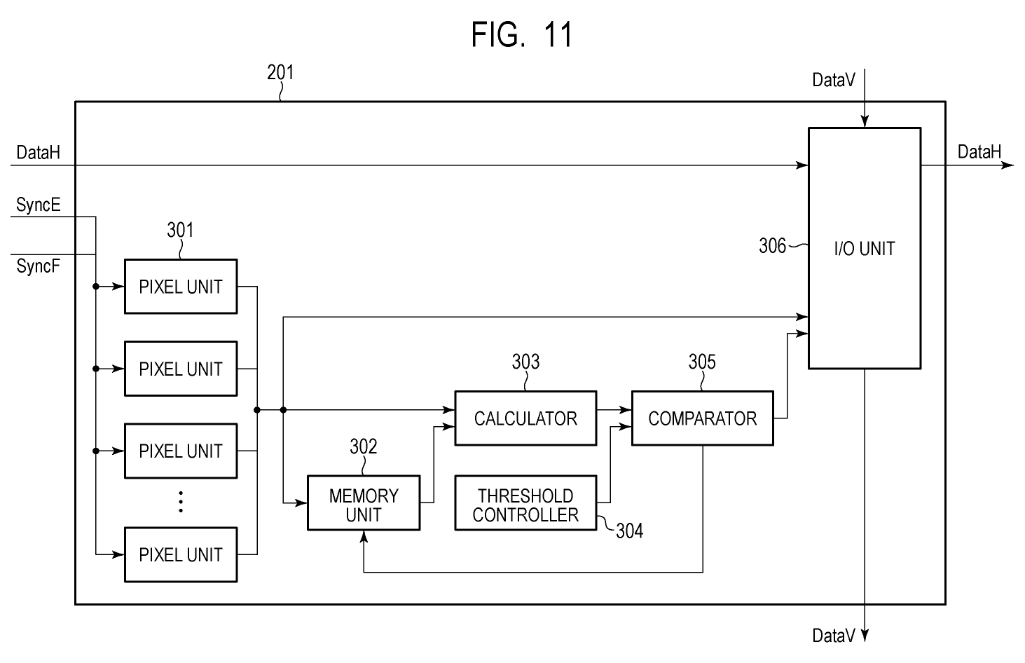

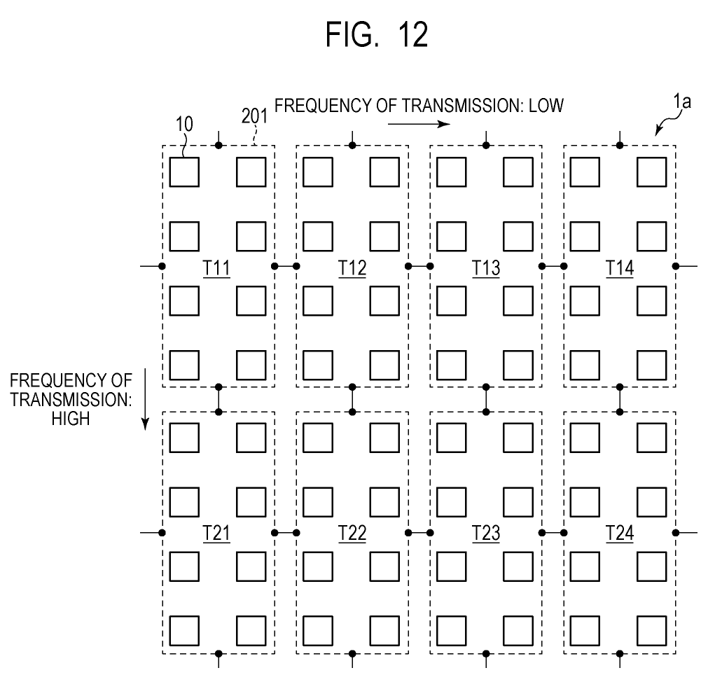

FIG. 12 is a diagram showing a modification of the layout of the pixels 10 in the tile area 201 according to the present embodiment. In each of the tile areas 201 according to the present modification, the pixels 10 are arranged in a matrix form, and the number of the pixels 10 arranged in the row direction is different from the number of the pixels 10 arranged in the column direction. Specifically, the layout of the pixels 10 in the tile area 201 according to the present modification may be determined depending on the frequency at which signals from the tile area 201 are transmitted or transferred in the row direction and the frequency at which signals are transmitted or transferred in the column direction. For example, in a case where signals output from the tile area 201 are transmitted at a relatively higher frequency in the column direction than in the row direction, the number of the pixels 10 in the tile area 201 is relatively greater in the column direction as shown in FIG. 12. In the example of the layout of pixels shown in FIG. 12, two pixels 10 are arranged in the row direction and four pixels 10 are arranged in the column direction in the tile area 201. On the other hand, in a case where signals output from the tile area 201 are transmitted at a relatively higher frequency in the row direction than in the column direction, the number of the pixels 10 in the tile area 201 is relatively greater in the row direction. The number of pixels 10 arranged in the row direction and the column direction may be changed depending on the frequency of transmission of signals in each direction. For example, as the frequency of transmitting the pixel signals in the column direction is relatively higher, the number of pixels 10 disposed in the column direction in the tile area 201 may be set to be relatively greater than the number of pixels 10 disposed in the row direction. On the other hand, as the frequency of transmitting the pixel signals in the row direction is relatively higher, the number of pixels 10 disposed in the row direction in the tile area 201 may be set to be relatively greater than the number of pixels 10 disposed in the column direction.

According to the present embodiment, signals output from the tile area 201 are sequentially transmitted or transferred to the first processor 203 or the second processor 204 via the I/O units 306 of the adjacent tile areas 201. Further, according to the modification shown in FIG. 12, the relatively larger number of pixels 10 are arranged in each tile area 201 in the direction in which the frequency of signal transmission is higher. That is, the present modification allows to reduce the number of times the pixel signals are transmitted or transferred to the adjacent tile areas 201 in the direction in which the transfer frequency is higher. Therefore, the photoelectric conversion device 100 according to the present modification allows to reduce power consumed when signals are transmitted or transferred.

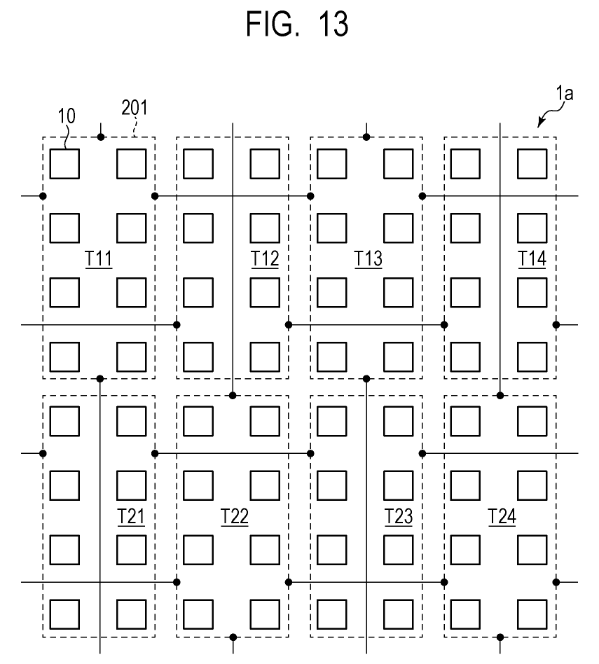

FIG. 13 is a diagram showing a modification of the pattern connecting the tile areas 201 according to the present embodiment. Signals output from the tile area 201 according to the present embodiment do not necessarily need to be transmitted to the tile areas 201 adjacent in the row direction and the column direction. For example, as shown in FIG. 13, the tile area T11 is directly connected to the tile area T13 that are not adjacent to each other. Similarly, the tile area T11 is directly connected to the tile area T31 that is not adjacent to each other. That is, signals output from the tile area T11 is directly transferred or transmitted to the non-adjacent tile areas T13 and T31 without passing through the adjacent tile areas T12 and T21. The present modification allows to further reduce the number of times of transferring or transmitting signals output from the tile area 201. Therefore, the photoelectric conversion device 100 according to the present modification allows to further reduce the power consumed when signals are transferred or transmitted.

The pattern connecting the tile areas 201 according to the present embodiment is not limited to the modification shown in FIG. 13. For example, signals output from the tile area T11 may be directly transmitted or transferred to tile areas that are more remote than the tile areas T13 and T31 (e.g., the tile areas T14 and T41).

According to the present embodiment, signals output from the tile area 201 are sequentially transferred to an I/O unit 306 of another tile area 201 via the I/O unit 306, and finally transmitted to the first processor 203 or the second processor 204. This configuration allows to reduce attenuation of signals generated in the vertical output lines and the horizontal output lines that become longer as the pixel array 1a becomes larger. That is, according to the present modification, it is not necessary to prepare separate circuits for compensating for attenuation of signals generated in the output lines, which allows to simplify the circuit design of the photoelectric conversion device.

### Third Embodiment

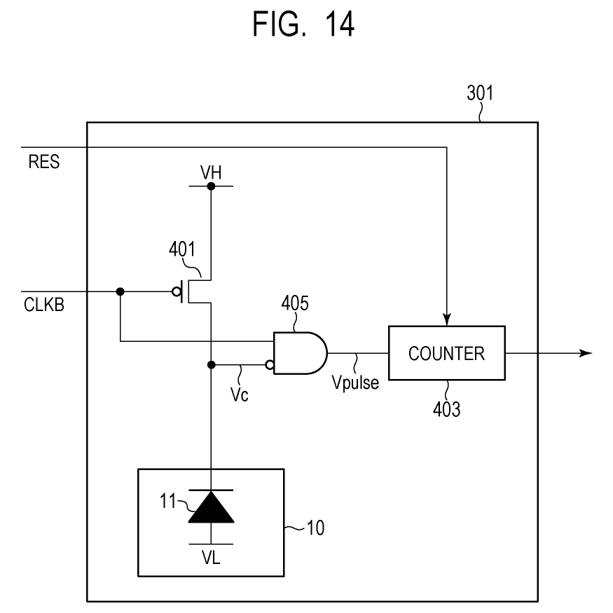

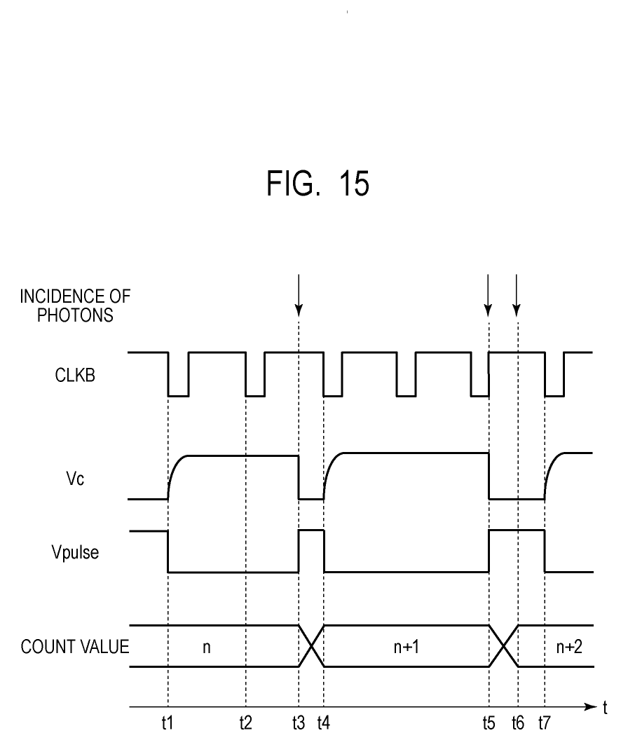

A photoelectric conversion device according to a third embodiment of the present disclosure will be described with reference to FIGS. 14 and 15, focusing on differences from the first and second embodiments.

FIG. 14 is a diagram showing a schematic configuration of the pixel unit 301 according to the present embodiment. The pixel unit 301 includes the pixel 10 including the APD 11, the PMOS transistor 401, the counter 403, and an AND circuit 405. A pulse signal CLKB is applied from the controller 202 to the gate of the PMOS transistor 401 and an input terminal of the AND circuit 405. The voltage VH is applied to one of the source and the drain of the PMOS transistor 401, and the other of the source and the drain is connected to the cathode of the APD 11 and another input terminal of the AND circuit 405. The voltage VL is applied to the anode of the APD 11. An output terminal of the AND circuit 405 is connected to the counter 403. The signal RES is input to the counter 403 from the controller 202. The controller 202 controls the counter 403 via the signal RES.

The AND circuit 405 receives, as an input, a signal obtained by inverting the signal Vc generated in response to the operation of the APD 11. That is, when the signal Vc is at a low level and the input signal CLKB is at a high level, the AND circuit 405 outputs to the counter 403 a waveform-shaped pulse signal Vpulse with a high-level.

FIG. 15 is a timing chart showing the operation of the pixel unit 301 according to the present embodiment. FIG. 15 shows timing charts of photons entering the pixel 10, the signal CLKB transmitted to the gate of the PMOS transistor 401 and the input terminal of the AND circuit 405, the signal Vc generated based on the operation of the APD 11, the pulse signal Vpulse whose waveform is shaped by the AND circuit 405, and the count value of the counter 403.

In a period before time t1, the signal CLKB is at a high level, the signal Vc is at a low level, the signal Vpulse is at a high level, and the count value is n. The high-level signal CLKB is applied to the gate of the PMOS transistor 401, and the PMOS transistor 401 is in the OFF state between the source and the drain. The signal Vc is at a low level, and the APD 11 is not charged.

At time t1, the signal CLKB transitions from a high level to a low level, and the PMOS transistor 401 switches from the OFF state to the ON state. At time t1, the low-level signal CLKB is input to the AND circuit 405, and the signal Vpulse transitions from a high level to a low level. The signal CLKB is maintained at a low level for a predetermined period from the time t1. The APD 11 is charged via the PMOS transistor 401, and the signal Vc transitions from a low level to a high level. The APD 11 is enabled to generate avalanche multiplication by incidence of a photon. In response to the transition of the signal Vc to a high level, the signal Vpulse is maintained at a low level. After a predetermined period elapses from the time t1, the signal CLKB transitions from a low level to a high level, and the PMOS transistor 401 switches from the ON state to the OFF state. Since the signal Vc is maintained at a high level, the signal Vpulse is maintained at a low level.

At time t2, the signal CLKB transitions from a high level to a low level, and the PMOS transistor 401 switches from the OFF state to the ON state. Since the APD 11 is already charged, the signal Vc is maintained at a high level, and the signal Vpulse is maintained at a low level. After a predetermined period elapses from the time t2, the signal CLKB transitions from a low level to a high level, and the PMOS transistor 401 switches from the ON state to the OFF state. Since the signal Vc is maintained at a high level, the signal Vpulse is maintained at a low level.

At time t3, a photon enters the APD 11, and the APD 11 generates avalanche multiplication. The signal Vc transitions from a high level to a low level due to the generation of avalanche multiplication and exceeds a logical threshold of the AND circuit 405. At time t3, the signal CLKB input to the AND circuit 405 is at a high level. Therefore, at time t3, the signal Vpulse transitions from a low level to a high level. In response to the transition of the signal Vpulse to a high level, the counter 403 increases the stored count value from n to n+1 by one LSb.

In the period from time t3 to time t4, the signal CLKB is maintained at a high level, and the PMOS transistor 401 is maintained in the OFF state. Therefore, in the period from time t3 to time t4, the APD 11 is not recharged, the signal Vc is maintained at a low level, and the signal Vpulse is maintained at a high level.

At time t4, the signal CLKB transitions from a high level to a low level, and the PMOS transistor 401 switches from the OFF state to the ON state. At time t4, the signal CLKB transitions to a low level, which causes the signal CLKB at a low level to be input to the AND circuit 405 at time t4, and the signal Vpulse transitions from a high level to a low level. The signal CLKB is maintained at a low level for a predetermined period from time t4. The APD 11 is recharged via the PMOS transistor 401, and the signal Vc transitions from a low level to a high level. The APD 11 is enabled to generate avalanche multiplication by incidence of a photon. In response to the transition of the signal Vc to a high level, the signal Vpulse is maintained at a low level. After a predetermined period elapses from the time t4, the signal CLKB transitions from a low level to a high level, and the PMOS transistor 401 switches from the ON state to the OFF state. Since the signal Vc is maintained at a high level, the signal Vpulse is maintained at a low level.

At time t5, a photon enters the APD 11, and the APD 11 generates avalanche multiplication. The signal Vc transitions from a high level to a low level due to the generation of avalanche multiplication and exceeds the logical threshold of the AND circuit 405. At time t5, the signal CLKB input to the AND circuit 405 is at a high level. Therefore, at time t5, the signal Vpulse transitions from a low level to a high level. In response to the transition of the signal Vpulse to a high level, the counter 403 increases the stored count value from n+1 to n+2 by one LSb.

In the period from time t5 to time t6, the signal CLKB is maintained at a high level, and the PMOS transistor 401 is maintained in the OFF state. Therefore, in the period from time t5 to time t6, the APD 11 is not recharged, the signal Vc is maintained at a low level, and the signal Vpulse is maintained at a high level.

At time t6, a photon enters the APD 11. However, since the APD 11 is not recharged in the period from the time t5 to the time t6, the signal Vc does not change from a low level at the time t6, and the signal Vpulse does not change from a high level. Therefore, at time t6, the counter 403 does not increase the stored count value, and the count value of n+2 is maintained.

At time t7, the signal CLKB transitions from a high level to a low level, and the PMOS transistor 401 switches from the OFF state to the ON state. At time t7, the low-level signal CLKB is input to the AND circuit 405, and the signal Vpulse transitions from a high level to a low level. The signal CLKB is maintained at a low level for a predetermined period from time t7. The APD 11 is charged via the PMOS transistor 401, and the signal Vc transitions from a low level to a high level. The APD 11 is enabled to generate avalanche multiplication by incidence of a photon. In response to the transition of the signal Vc to a high level, the signal Vpulse is maintained at a low level. After a predetermined period elapses from time t7, the signal CLKB transitions from a low level to a high level, and the PMOS transistor 401 switches from the ON state to the OFF state. Since the signal Vc is maintained at a high level, the signal Vpulse is maintained at a low level.

In the present embodiment, the period for counting photons is controlled by the signal CLKB. In a case where the event detection pixels 10a and the imaging pixels 10b are driven at different frame rates, the signal CLKB is changed according to the respective frame rates. This configuration allows to independently control the event detection pixels 10a and the imaging pixels 10b. Specifically, the event detection pixels 10a and the imaging pixels 10b may be operated based on separate signals CLKB having different frequencies. For example, in a case where the exposure period of the imaging pixels 10b is set to be twice as long as the exposure period of the event detection pixels 10a, the controller 202 supplies for the imaging pixels 10b another pulse signal CLKB having a counting period that is twice as long as a counting period of the pulse signal CLKB supplied to the event detection pixels 10a in one cycle. Controlling a ratio between the counting period and the cycle of the signal CLKB to be constant according to the maximum value that can be counted by the counter 403 allows to efficiently use the counter 403.

According to the present embodiment, the APD 11 is charged based on the signal CLKB. For example, in a case where there are two or more photons incident within a period of one pulse of the signal CLKB under high illuminance, the counter 403 counts only the initial incident photon. That is, under an environment having illuminance higher than a predetermined criterion, the upper limit of the number counted by the counter 403 in a predetermined period can be set to the number of pulses of the signal CLKB input to the pixel unit 301 in the same period.

### Fourth Embodiment

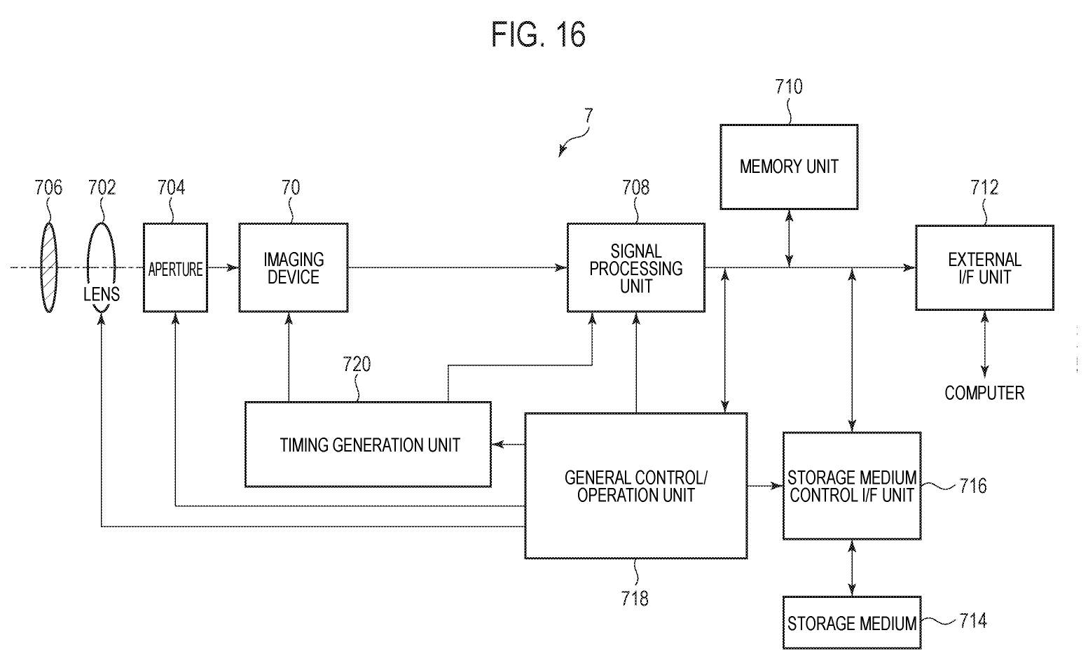

FIG. 16 is a block diagram of an imaging system according to the present embodiment. The photoelectric conversion device in the above-described embodiment can be applied to various imaging systems. Examples of the imaging system include a digital still camera, a digital camcorder, a camera head, a copier, a fax machine, a mobile phone, an in-vehicle camera, an observation satellite, and a monitoring camera. FIG. 16 shows a block diagram of a digital still camera as an example of the imaging system.

An imaging system 7 includes a barrier 706, a lens 702, an aperture 704, an imaging device 70, a signal processing unit 708, a timing generation unit 720, a general control/operation unit 718, a memory unit 710, a storage medium control interface (I/F) unit 716, a storage medium 714, and an external I/F unit 712. The barrier 706 protects the lens, and the lens 702 forms an optical image of the subject on the imaging device 70. The aperture 704 varies the amount of light passing through the lens 702. The imaging device 70 is configured like the photoelectric conversion device of the above-described embodiments, and converts an optical image formed by the lens 702 into image data. The signal processing unit 708 compresses various corrections and data on the imaging data output from the imaging device 70.

The timing generation unit 720 outputs various timing signals to the imaging device 70 and the signal processing unit 708. The general control/operation unit 718 entirely controls the digital still camera, and the memory unit 710 temporarily stores image data. The storage medium control I/F unit 716 is an interface for recording or reading image data on or from the storage medium 714, and the storage medium 714 is a detachable storage medium such as a semiconductor memory for recording or reading imaging data. The external I/F unit 712 is an interface for communicating with an external computer or the like. The timing signals may be input from the outside of the imaging system, and the imaging system may include at least the imaging device 70 and the signal processing unit 708 that processes the image signal output from the imaging device 70.

In the present embodiment, the imaging device 70 and the signal processing unit 708 are provided on different semiconductor substrates, but the imaging device 70 and the signal processing unit 708 may be formed on the same semiconductor substrate.

Each pixel includes a first photoelectric conversion unit and a second photoelectric conversion unit. The signal processing unit 708 may process pixel signals generated based on the charge generated in the first photoelectric conversion unit, process pixel signals generated based on the charge generated in the second photoelectric conversion unit, and acquire information of distance from the imaging device 70 to a subject.

### Fifth Embodiment

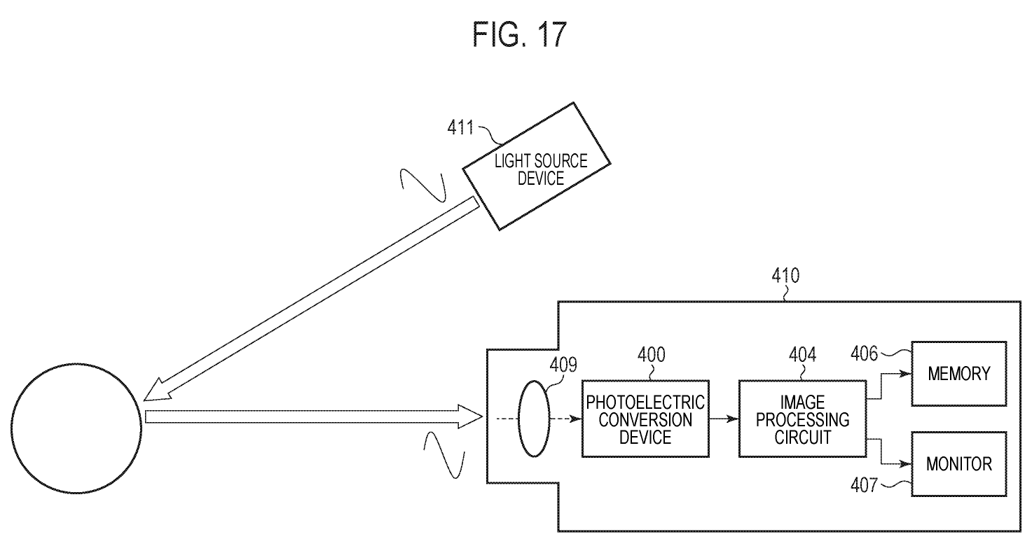

FIG. 17 is a block diagram of a light detection system according to the present embodiment, which is a distance image sensor using the photoelectric conversion device according to the above-described embodiments.

As shown in FIG. 17, a distance image sensor 410 includes a photoelectric conversion device 400, an image processing circuit 404, a memory 406, a monitor 407, and an optical system 409. The distance image sensor 410 receives light (modulated light, pulsed light) that is emitted from a light source device 411 toward a subject and reflected by the surface of the subject. The distance image sensor 410 can acquire a distance image according to a distance to the subject based on a period of time from light emission to light reception.

The optical system 409 includes one lens or multiple lenses, guides image light (incident light) from the subject to the photoelectric conversion device 400, and forms an image on a light receiving surface (sensor unit) of the photoelectric conversion device 400.

The photoelectric conversion device described in each of the above-described embodiments can be applied as the photoelectric conversion device 400. The photoelectric conversion device 400 supplies a distance signal indicating a distance obtained from the light reception signal to the image processing circuit 404.

The image processing circuit 404 performs image processing for forming a distance image based on the distance signal supplied from the photoelectric conversion device 400. The distance image (image data) obtained by the image processing may be displayed on the monitor 407 and stored (recorded) in the memory 406.

Applying the photoelectric conversion device described above allows the distance image sensor 410 configured as described above to acquire more accurate distance images because of the improved characteristics of pixels.

### Sixth Embodiment

The techniques according to the present disclosure can be applied to various products. For example, the techniques according to the present disclosure may be applied to an endoscopic surgery system.

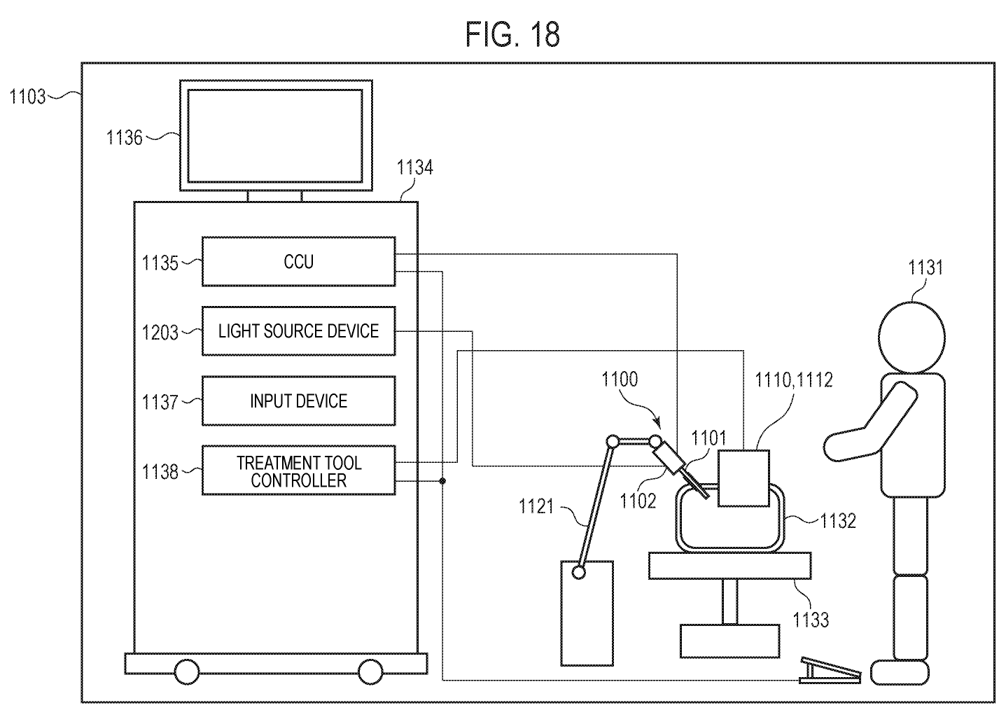

FIG. 18 is a schematic diagram of an endoscopic surgery system according to the present embodiment. FIG. 18 shows a state in which an operator (surgeon) 1131 performs surgery on a patient 1132 on a patient bed 1133 using an endoscopic surgery system 1103. As shown in the figure, the endoscopic surgery system 1103 includes an endoscope 1100, a surgical tool 1110, and a cart 1134 on which various devices for endoscopic surgery are mounted.

The endoscope 1100 includes a lens barrel 1101 that is inserted into a body cavity of the patient 1132 by a predetermined length from a distal end, a camera head 1102 connected to a proximal end of the lens barrel 1101, and an arm 1121. Although FIG. 18 shows the endoscope 1100 configured as a so-called rigid mirror having a rigid lens barrel 1101, the endoscope 1100 may be configured as a so-called flexible mirror having a flexible lens barrel.

The distal end of the lens barrel 1101 is provided with an opening into which an objective lens is fitted. A light source device 1203 is connected to the endoscope 1100, and light generated by the light source device 1203 is guided to the tip of the lens barrel 1101 by a light guide extended inside the lens barrel, and is irradiated toward an observation target in the body cavity of the patient 1132 via the objective lens. Note that the endoscope 1100 may be a direct-viewing mirror, or may be an oblique-viewing mirror or a side-viewing mirror.

An optical system and a photoelectric conversion device are provided inside the camera head 1102, and reflected light (observation light) from an observation target is condensed on the photoelectric conversion device by the optical system. The observation light is photoelectrically converted by the photoelectric conversion device, and an electrical signal corresponding to the observation light, that is, an image signal corresponding to the observation image is generated. The photoelectric conversion device described in each of the above-described embodiments can be used as the photoelectric conversion device. The image signal is transmitted as RAW data to a camera control unit (CCU) 1135.

The CCU 1135 is configured by a CPU (Central Processing Unit), a GPU (Graphics Processing Unit), and the like, and integrally controls operations of the endoscope 1100 and a display device 1136. Further, the CCU 1135 receives an image signal from the camera head 1102, and performs various types of image processing for displaying an image based on the image signal, such as development processing (demosaic processing).

Under the control of the CCU 1135, the display device 1136 displays an image based on the image signal subjected to the image processing by the CCU 1135.

The light source device 1203 includes, for example, a light source such as an LED (Light Emitting Diode), and supplies the endoscope 1100 with irradiation light when capturing an image of a surgical site or the like.

An input device 1137 is an input interface to the endoscopic surgery system 1103. The user can input various kinds of information and input instructions to the endoscopic surgery system 1103 via the input device 1137.

A treatment tool controller 1138 controls the operations of the energy treatment tool 1112 for tissue cauterization, incision, sealing of blood vessels, or the like.

The light source device 1203 can supply irradiation light to the endoscope 1100 when imaging the surgical site, and the light source device 1203 may be, for example, a white light source using an LED, a laser light source, or a combination thereof. In a case where a white light source is configured by a combination of RGB laser light sources, the output intensity and output timing of each color (each wavelength) can be controlled with high accuracy. Therefore, the white balance of the captured image can be adjusted in the light source device 1203. In addition, in this case, laser light from each of the RGB laser light sources may be irradiated to the observation target in a time division manner, and the operation of the imaging elements of the camera head 1102 may be controlled in synchronization with the irradiation timing. Thus, it is possible to capture images corresponding to RGB in a time-division manner. According to such a method, it is possible to obtain a color image without providing a color filter on the imaging element.

Further, the operation of the light source device 1203 may be controlled to change the intensity of the light output from the light source device 1203 every predetermined time. By controlling the operation of the image sensor of the camera head 1102 in synchronization with the timing of changing the intensity of light to acquire images in a time division manner and synthesizing the image, it becomes possible to generate an image having a high dynamic range without so-called black blur and white blur.

Further, the light source device 1203 may be configured to be capable of supplying light in a predetermined wavelength band adapted for special light observation. For example, wavelength dependency of absorption of light in body tissue can be utilized in the special light observation. Specifically, a predetermined tissue such as a blood vessel in the superficial layer of a mucous membrane is photographed with high contrast by irradiating light in a narrow band as compared with irradiation light (that is, white light) used in normal observation. Alternatively, in the special light observation, fluorescence observation in which an image is obtained by fluorescence generated by irradiation with excitation light may be performed. In the fluorescence observation, a body tissue is irradiated with excitation light to observe fluorescence from the body tissue, or a reagent such as indocyanine green (ICG) is locally injected in a body tissue, and the body tissue is irradiated with excitation light corresponding to a fluorescence wavelength of the reagent to obtain a fluorescence image. The light source device 1203 may be configured to be capable of supplying narrowband light and/or excitation light corresponding to such special light observation.

### Seventh Embodiment

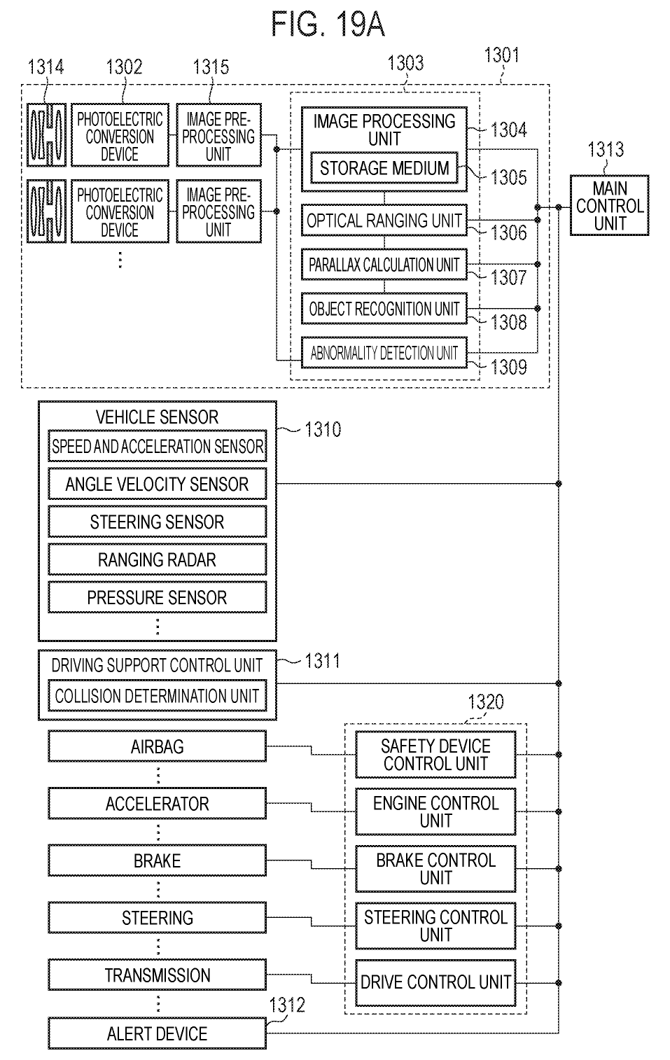

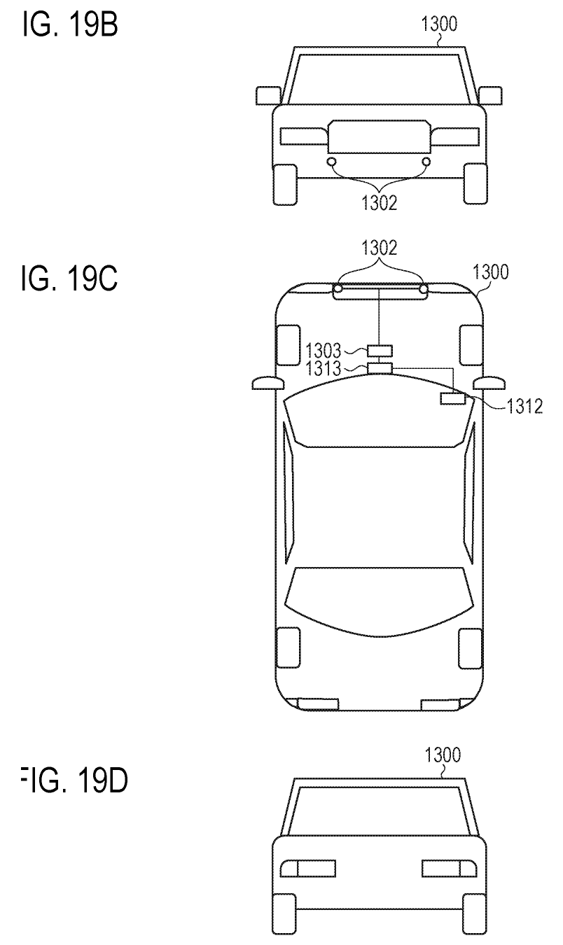

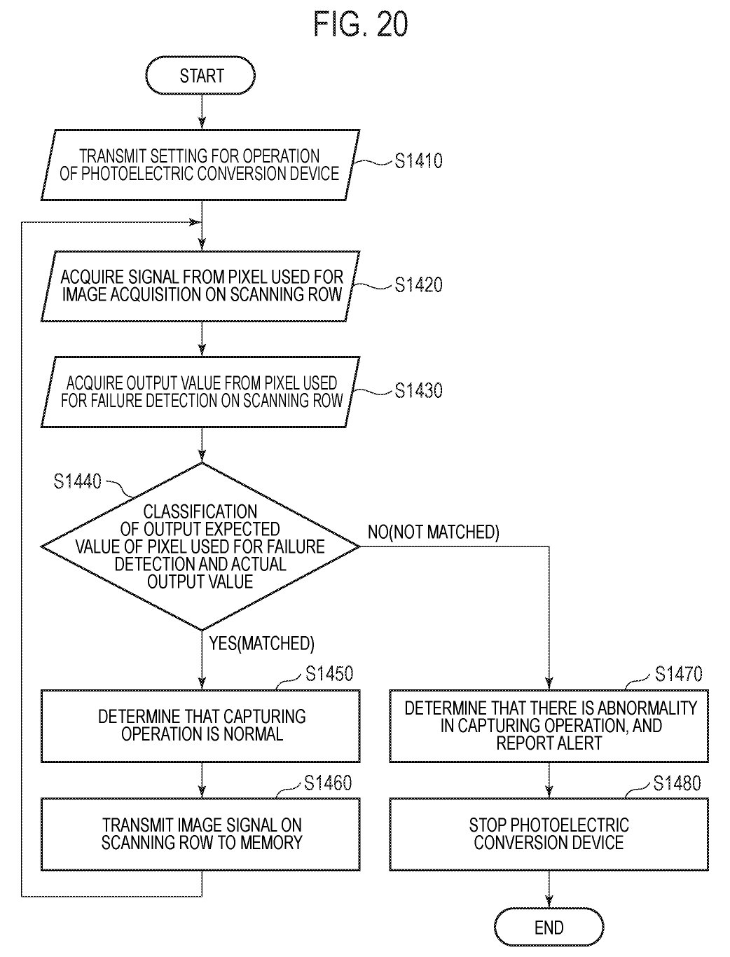

A light detection system and a mobile object of the present embodiment are described with reference to FIGS. 19A, 19B, 19C, 19D, and 20 . In the present embodiment, an example of an in-vehicle camera is shown as a light detection system.

FIG. 19A is a schematic diagram of a light detection system according to the present embodiment, and shows an example of a vehicle system and a light detection system mounted on the vehicle system. A light detection system 1301 includes a photoelectric conversion device 1302, an image pre-processing unit 1315, an integrated circuit 1303, and an optical system 1314. The optical system 1314 forms an optical image of a subject on the photoelectric conversion device 1302. The photoelectric conversion device 1302 converts the optical image of the subject formed by the optical system 1314 into an electrical signal. The photoelectric conversion device 1302 is the photoelectric conversion device of any of the above-described embodiments. The image pre-processing unit 1315 performs predetermined signal processing on the signal output from the photoelectric conversion device 1302. The function of the image pre-processing unit 1315 may be incorporated in the photoelectric conversion device 1302. The light detection system 1301 is provided with at least two sets of the optical system 1314, the photoelectric conversion device 1302, and the image pre-processing unit 1315, and an output from each set of the image pre-processing unit 1315 is input to the integrated circuit 1303.

The integrated circuit 1303 is an integrated circuit for an imaging system application, and includes an image processing unit 1304 having a storage medium 1305, an optical ranging unit 1306, a parallax calculation unit 1307, an object recognition unit 1308, and an abnormality detection unit 1309. The image processing unit 1304 performs image processing such as development processing and defect correction on the output signal of the image pre-processing unit 1315. The storage medium 1305 primarily stores captured images and stores defect positions of the imaging pixel. The optical ranging unit 1306 performs focusing of an object and distance measurement. The parallax calculation unit 1307 calculates distance measurement information from multiple pieces of image data acquired by the multiple photoelectric conversion devices 1302. The object recognition unit 1308 performs recognition of a subject such as a car, a road, a sign, or a person. Upon detecting an abnormality in the photoelectric conversion device 1302, the abnormality detection unit 1309 notifies a main control unit 1313 of the abnormality.

The integrated circuit 1303 may be realized by dedicatedly designed hardware, may be realized by a software module, or may be realized by a combination thereof. Further, the integrated circuit 1303 may be realized by FPGA (Field Programmable Gate Array), ASIC (Application Specific Integrated Circuit), or the like, or may be realized by a combination thereof.

The main control unit 1313 integrally controls the operations of the light detection system 1301, a vehicle sensor 1310, a control unit 1320, and the like. Instead of providing the main control unit 1313, the light detection system 1301, the vehicle sensor 1310, and the control unit 1320 may be configured to individually have a communication interface, and each may transmit and receive control signals via a communication network according to, for example, the CAN standard.

The integrated circuit 1303 has a function of receiving control signals from the main control unit 1313 or transmitting control signals or setting values to the photoelectric conversion device 1302 by its own controller.

The light detection system 1301 is connected to the vehicle sensor 1310, and can detect traveling states of a host vehicle such as a vehicle speed, a yaw rate, and a steering angle, an environment outside the host vehicle, and states of other vehicles and obstacles. The vehicle sensor 1310 also works as a distance information acquisition unit that acquires information of distance to an object. In addition, the light detection system 1301 is connected to a driving support control unit 1311 that performs various kinds of driving support such as automatic steering, automatic traveling, and a collision prevention function. In particular, the collision determination function forecasts a collision with another vehicle or an obstacle based on the detection results of the light detection system 1301 and the vehicle sensor 1310, and determines whether or not there is a collision. The above configuration allows to perform avoidance control when a collision is anticipated and activate the safety device at the time of the collision.

The light detection system 1301 is also connected to an alert device 1312 that issues an alert to a driver based on the determination result of the collision determination unit. For example, if the determination result of the collision determination unit indicates that the possibility of collision is high, the main control unit 1313 performs vehicle control such as braking, returning the accelerator, or suppressing the engine output, thereby realizing avoidance of collision and reduction of damage. The alert device 1312 gives a warning to the user by means of, for example, issuing a warning such as a sound, displaying warning information on a display screen of a car navigation system, a meter panel, or the like, or imparting vibration to a seat belt and a steering wheel.

The light detection system 1301 of the present embodiment is capable of capturing an image of the surroundings of a vehicle, for example, the front or the rear. FIG. 19B, FIG. 19C, and FIG. 19D are schematic views of a mobile object in the present embodiment, and show a configuration for capturing an image of the front side of the vehicle using the light detection system 1301.

The two photoelectric conversion devices 1302 are disposed in front of a vehicle 1300. Specifically, it is preferable that a center line with respect to an advancing/retracting direction or an outer shape (for example, a vehicle width) of the vehicle 1300 be regarded as an axis of symmetry, and the two photoelectric conversion devices 1302 be arranged line-symmetrically with respect to the axis of symmetry. Accordingly, it is possible to effectively acquire distance information between the vehicle 1300 and an object to be captured and determine the possibility of collision. In addition, it is preferable that the photoelectric conversion devices 1302 be disposed at a position that does not interfere with the driver's visual field when the driver visually recognizes a situation outside the vehicle 1300 from the driver's seat. The alert device 1312 is preferably disposed at a position where it easily enters the field of view of the driver.

Next, an operation for detecting failure of the photoelectric conversion device 1302 in the light detection system 1301 will be described with reference to FIG. 20. FIG. 20 is a flowchart showing an operation of the light detection system according to the present embodiment. The operation for detecting failure of the photoelectric conversion device 1302 may be performed according to steps S1410 to S1480.

In step S1410, settings for the start-up of the photoelectric conversion device 1302 are performed. That is, setting information for the operation of the photoelectric conversion device 1302 is transmitted from the outside (for example, the main control unit 1313) of the light detection system 1301 or the inside of the light detection system 1301, and the photoelectric conversion device 1302 starts the imaging operation and the operation for detecting failure.

Then, in step S1420, the photoelectric conversion device 1302 acquires pixel signals from the effective pixels. In step S1430, the photoelectric conversion device 1302 acquires an output value from a failure detection pixel provided for detecting failure. The failure detection pixel includes a photoelectric conversion element as well as the effective pixels. A predetermined voltage is written to the photoelectric conversion element. The failure detection pixel outputs a signal corresponding to the voltage written in the photoelectric conversion element. Note that step S1420 and step S1430 may be executed in reverse order.

Then, in step S1440, the light detection system 1301 determines whether an expected value output from the failure detection pixel is consistent with an output value from the actual failure detection pixel. If determined as a result of the determination in step S1440 that the expected value matches the actual output value, the light detection system 1301 proceeds to the process of step S1450 to determine that the imaging operation is normally performed, and proceeds to the process of step S1460. In step S1460, the light detection system 1301 transmits pixel signals of the scanning row to the storage medium 1305 and temporarily stores the pixel signals. Thereafter, the light detection system 1301 returns to the process of step S1420 and continues the operation for detecting failure. On the other hand, if determined as a result of the determination in step S1440 that the expected value does not match the actual output value, the light detection system 1301 proceeds to the process of step S1470. In step S1470, the light detection system 1301 determines that there is an abnormality in the imaging operation, and issues an alert to the main control unit 1313 or the alert device 1312. The alert device 1312 causes a display unit to display that an abnormality has been detected. Thereafter, in step S1480, the light detection system 1301 stops the photoelectric conversion device 1302 and ends the operation of the light detection system 1301.

In the present embodiment, an example in which the flowchart is looped for each row is shown, but the flowchart may be looped for each plurality of rows, or the operation for detecting failure may be performed for each frame. The alert issued in step S1470 may be configured to provide an alert to the outside of a vehicle via a wireless network.

The present embodiment has shown the control for avoiding collision with another vehicle, but the present technique is also applicable for controlling a vehicle to follow another vehicle for automatic driving, for controlling a vehicle for automatic driving not to protrude from a lane, and the like. Further, the light detection system 1301 is not limited to a vehicle such as an own vehicle, and can be applied to, for example, mobile objects (mobile devices) such as a ship, an aircraft, an industrial robot, or the like. In addition, the present technique is not limited to mobile objects, and can be widely applied to devices using object recognition, such as the Intelligent Transport Systems (ITS). The photoelectric conversion device of the present disclosure may be further configured to be capable of acquiring various kinds of information such as information of distance.

### Eighth Embodiment

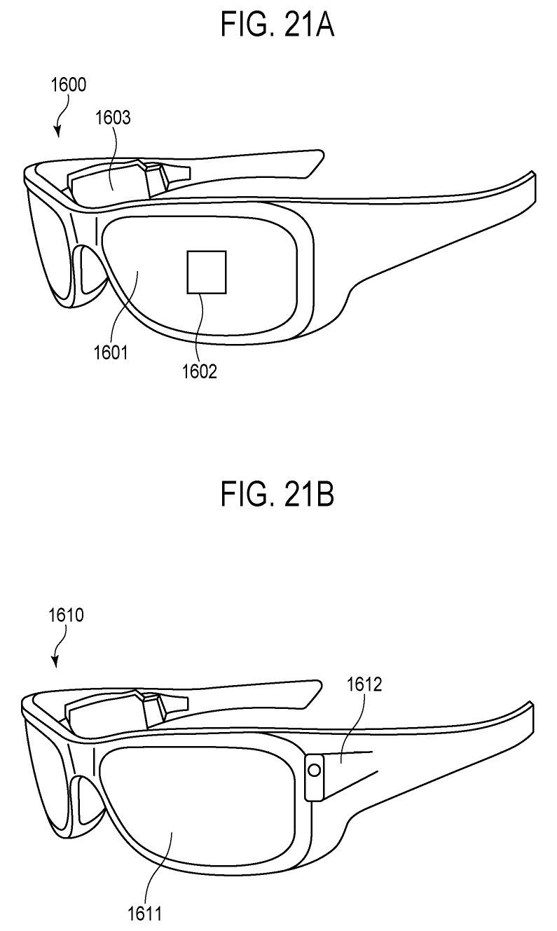

FIG. 21A is a diagram showing a specific example of an electronic device in this embodiment, and FIG. 21A shows glasses 1600 (smart glasses). The glasses 1600 are provided with the photoelectric conversion device 1602 described in the above embodiments. A display device including a light-emitting device such as an OLED or an LED may be provided on the back surface side of a lens 1601. One photoelectric conversion device 1602 may be provided, or multiple photoelectric conversion devices 1602 may be provided. Further, multiple types of photoelectric conversion devices may be combined. The arrangement position of the photoelectric conversion device 1602 is not limited to the position shown in FIG. 21A.

The glasses 1600 further include a control device 1603. The control device 1603 functions as a power supply that supplies power to the photoelectric conversion device 1602 and the above-described display device. The control device 1603 controls the operations of the photoelectric conversion device 1602 and the display device. The lens 1601 is provided with an optical system for condensing light on the photoelectric conversion device 1602.

FIG. 21B shows glasses 1610 (smart glasses) as an example of applications. The glasses 1610 include a control device 1612 on which a photoelectric conversion device corresponding to the photoelectric conversion device 1602 and a display device are mounted. The photoelectric conversion device in the control device 1612 and an optical system for projecting light emitted from the display device are formed in the lens 1611, and an image is projected on the lens 1611. The control device 1612 functions as a power supply that supplies power to the photoelectric conversion device and the display device, and controls the operations of the photoelectric conversion device and the display device. The control device 1612 may include a gaze detection unit that detects the gaze of the wearer. The gaze may be detected using infrared light. An infrared light emitting unit emits infrared light to an eyeball of a user who is gazing at a displayed image. A captured image of the eyeball is obtained at an imaging unit having a light receiving element by detecting reflected light of the emitted infrared light from the eyeball. A reduction unit configured to reduce light from the infrared light emitting unit to the display unit in a plan view reduces degradation in image quality.

The gaze of the user with respect to the displayed image is detected from the captured image of the eyeball obtained by capturing the infrared light. Any known technique can be applied for detecting the gaze using the captured image of the eyeball. As an example, it is possible to use a gaze detection method based on a Purkinje image due to reflection of irradiation light on the cornea.

More specifically, it is possible to execute the gaze detection process based on the pupillary corneal reflection method. The gaze of the user is detected by calculating, by using the pupil corneal reflection method, a gaze vector representing the orientation (rotation angle) of the eyeball based on an image of the pupil included in the captured image of the eyeball and the Purkinje image.

The display device according to the present embodiment may include a photoelectric conversion device having a light receiving element, and control a displayed image of the display device based on gaze (line-of-sight) information of a user obtained from the photoelectric conversion device.

Specifically, the display device determines, based on the line-of-sight information, a first field-of-view area that the user gazes at and a second field-of-view area that is an area other than the first field-of-view area. The first field-of-view area and the second field-of-view area may be determined by the control device of the display device or may be determined by an external control device. In the display area of the display device, the display resolution of the first field-of-view area may be controlled to be higher than the display resolution of the second field-of-view area. That is, the resolution of the second field-of-view area may be lower than the resolution of the first field-of-view area.

The display area may include a first display area and a second display area different from the first display area. An area having a high priority may be determined from the first display area and the second display area based on the line-of-sight information. The first field-of-view area and the second field-of-view area may be determined by the control device of the display device or may be determined by an external control device. The resolution of the high priority area may be controlled to be higher than the resolution of the area other than the high priority area. That is, the area having a relatively low priority may have a lower resolution.

Note that AI (Artificial Intelligence) may be used to determine the first field-of-view area and the area with high priority. The AI may use images of the eyeballs and the directions actually viewed by the eyeballs of the images as teacher data, and the AI may be a model configured to estimate, from the image of the eyeball, an angle of the line of sight and a distance to a target object ahead of the line of sight. The AI program may be provided in either the display device or the photoelectric conversion device, or may be provided in an external device. In a case where the external device has the AI program, the AI program may be transmitted from the server or the like to the display device via communications.

In the case of performing display control based on visual recognition detection, the present embodiment can be preferably applied to smart glasses further including a photoelectric conversion device that captures an image of the outside. The smart glasses can display captured external information in real time.

The present disclosure allows to solve the problem that may occur due to the difference in configuration between the detection pixel and the counting pixel.

### Other Embodiments

The scope of the present technique is not limited to the above-described embodiments, and it is possible to make various modifications. For example, an example in which a part of the configuration of any of the embodiments is added to another embodiment and an example in which a part of the configuration of another embodiment is replaced with another embodiment also correspond to the embodiment of the present technique.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A photoelectric conversion device comprising:
a pixel array including a plurality of pixel units arranged in a matrix form, each pixel unit having an avalanche photodiode and a counter that generates a count value based on photons entering the avalanche photodiode;
a plurality of tile areas defined by dividing the pixel array into a matrix form; and
a memory unit arranged in each of the plurality of tile areas, and storing a reference value that is used for detecting an event based on the count value;
wherein at least one of the pixel units in the tile area is an event detection pixel unit to detect the event,
wherein the tile area includes the two or more event detection pixel units, and
wherein the memory unit is shared by the two or more event detection pixel units.

2. The photoelectric conversion device according to claim 1, wherein each of the plurality of tile areas includes a comparator that detects the event based on a difference between the reference value and the count value.

3. The photoelectric conversion device according to claim 2,
wherein the tile area includes the two or more event detection pixel units, and
wherein the comparator is shared by the two or more event detection pixel units.

4. The photoelectric conversion device according to claim 1, wherein the memory unit is arranged in the respective event detection pixel units.

5. The photoelectric conversion device according to claim 1, wherein the reference value is the count value of the event detection pixel unit obtained in a period during which the event has been detected.

6. The photoelectric conversion device according to claim 1, wherein, in a case where the event is detected, the reference value is updated to the count value of the event detection pixel unit.

7. The photoelectric conversion device according to claim 2, wherein the comparator compares the difference with a predetermined threshold value to determine that the event has been detected.

8. The photoelectric conversion device according to claim 7,
wherein the predetermined threshold value includes a first threshold value and a second threshold value different from the first threshold value,
wherein, in a case where the difference is a positive number, the difference is compared with the first threshold value, and
wherein, in a case where the difference is a negative number, the difference is compared with the second threshold value.

9. The photoelectric conversion device according to claim 8,
wherein the first threshold value and the second threshold value are changed based on a change in the reference value, and
wherein the amount of change in the first threshold value based on the change in the reference value is different from the amount of change in the second threshold value based on the change in the reference value.

10. The photoelectric conversion device according to claim 7 further comprising a threshold controller that transmits the predetermined threshold value to the comparator,
wherein the threshold controller is arranged in the tile area.

11. The photoelectric conversion device according to claim 1, wherein each of the plurality of tile areas includes an input/output unit that transfers a signal output from a first tile area to a second tile area.

12. The photoelectric conversion device according to claim 11,
wherein the number of the pixel units arranged in a row direction is different from the number of the pixel units arranged in a column direction,
wherein, the higher a frequency of transferring the signal in the row direction is than a frequency of transferring the signal in the column direction, the relatively greater the number of the pixel units arranged in the row direction is set than the number of the pixel units arranged in the column direction, and
wherein, the higher a frequency of transferring the signal in the column direction is than a frequency of transferring the signal in the row direction, the relatively greater the number of the pixel units arranged in the column direction is set than the number of the pixel units arranged in the row direction.

13. The photoelectric conversion device according to claim 1,
wherein the avalanche photodiode is charged in response to a pulse signal input to the pixel unit,
wherein the plurality of pixel units includes the event detection pixel unit and an imaging pixel unit for capturing an image, and
wherein a frequency of the pulse signal input to the event detection pixel unit is different from a frequency of the pulse signal input to the imaging pixel unit.

14. The photoelectric conversion device according to claim 1,
wherein the avalanche photodiode is charged in response to a pulse signal input to the pixel unit,
wherein the plurality of pixel units includes the event detection pixel unit and an imaging pixel unit for capturing an image, and
wherein a period of time for generating the count value in one period of the pulse signal input to the event detection pixel unit is different from a period of time for generating the count value in one period of the pulse signal input to the imaging pixel unit.

15. The photoelectric conversion device according to claim 1 further comprising a selecting switch for changing the number of the event detection pixel units.

16. The photoelectric conversion device according to claim 1 further comprising a selecting switch for selecting, from the plurality of pixel units, a pixel unit that operates as the event detection pixel unit.

17. The photoelectric conversion device according to claim 2, wherein, in each of the plurality of tile areas, the counter is arranged relatively on the outside of the memory unit and the comparator.

18. A photoelectric conversion device comprising:
a pixel array including a plurality of pixel units arranged in a matrix form, each pixel unit having an avalanche photodiode and a counter that generates a count value based on photons entering the avalanche photodiode;
a plurality of tile areas defined by dividing the pixel array into a matrix form; and
a memory unit arranged in each of the plurality of tile areas, and storing a reference value that is used for detecting an event based on the count value;
wherein each of the plurality of tile areas includes a comparator that detects the event based on a difference between the reference value and the count value,
wherein at least one of the pixel units in the tile area is an event detection pixel unit to detect the event,
wherein the tile area includes the two or more event detection pixel units, and
wherein the comparator is shared by the two or more event detection pixel units.

19. The photoelectric conversion device according to claim 1, wherein the photoelectric conversion device is a back-illuminated device.

20. An imaging system comprising:
an imaging device including the photoelectric conversion device according to claim 1; and
a signal processor that processes imaging data output from the imaging device.

21. A movable body comprising:
the photoelectric conversion device according to claim 1;
a distance information acquisition unit that acquires, based on a signal output from the photoelectric conversion device, information of distance to an object; and
a controller that controls the movable body based on the information of distance.
